(19) United States
(12) Patent Application Publication
(10) Pub. No.: US 2012/0042178 A1
(43) Pub. Date: Feb. 16, 2012

(54) Peripheral Device

(75) Inventors: Suguru Ishii, Nagoya-shi (JP); Tsukasa Ito, Nagoya-shi (JP); Kenji Kato, Nagoya-shi (JP)

(73) Assignee: BUFFALO INC., Nagoya-shi (JP)

(21) Appl. No.: 13/205,644

(22) Filed: Aug. 9, 2011

(30) Foreign Application Priority Data
Aug. 10, 2010 (JP) 2010-179241

(51) Int. Cl. G06F 1/26

(52) U.S. Cl. 713/300

(57) ABSTRACT

Provided is a peripheral device including: a connection portion capable of selectively connecting to multiple types of connectors corresponding to multiple types of interfaces, the connection portion including a power terminal for receiving a supply of power from a host device via a connector; a control section for initiating, upon receiving a supply of power, a connection process to form a logical connection with the host device by using any one of the multiple types interfaces; a power line connecting the control section and the terminal; and a delay process section for delaying supply of power to the control section having started by the connector being connected to the connection portion, for a predetermined time, the delay process section being disposed along the power line.

### CROSS REFERENCE TO RELATED APPLICATION

The disclosure of Japanese Patent Application No. 2010-179241, filed on Aug. 10, 2010, is incorporated herein by reference.

### BACKGROUND OF THE INVENTION

1. Field of the Invention

The present invention relates to peripheral devices for conducting data communication with host devices.

2. Description of the Background Art

Through a variety of interfaces, connections are made between host devices such as personal computers and peripheral devices such as external storage devices to conduct data communications. Known examples of this sort of interface include the universal serial bus (USB) interface (cf., for example, Japanese Laid-Open Patent Publication No. 2009-289124). As USB interfaces, in addition to interfaces conforming to USB 2.0 (referred to simply as “USB 2.0 interfaces” hereinafter), interfaces conforming to USB 3.0 (referred to simply as “USB 3.0 interfaces” hereinafter) are becoming more common in recent years.

USB 2.0 and USB 3.0 differ in terms of specifications for data communications—the communication system (half-duplex communication, full-duplex communication), number of signal lines, etc. Thus, while the maximum data transmission rate for the USB 2.0 interface is 480 Mbps, the maximum data transmission rate for the USB 3.0 interface is 5 Gbps. This means that the USB 3.0 interface can conduct data communications at higher speeds compared to the USB 2.0 interface. In addition, the physical specification of the USB 3.0 interface port allows downward compatibility. Therefore, in addition to male-type USB connectors conforming to USB 3.0 (referred to as “USB 3.0 connectors” hereinafter), male-type USB connectors conforming to USB 2.0 (referred to as “USB 2.0 connectors” hereinafter) can be connected to USB ports conforming to USB 3.0 (referred to as “USB 3.0 ports” hereinafter). (Cf., for example, http://ja.wikipedia.org/wiki/USB, and http://monoist.atmarkit.co.jp/feledev/articles/mononews/05/mononews05_a.html).

However, when USB 3.0 connectors are plugged into respective USB 3.0 ports of a host device and a peripheral device to physically connect two devices, it can happen that the process of establishing a logical connection between the peripheral device and the host device starts and ends before the USB 3.0—conforming terminals have all come into complete physical contact. In such a case, the host device mistakenly recognizes the peripheral device as a USB 2.0 device that conducts data communications using the USB 2.0 interface.

If the host device mistakenly recognizes the peripheral device as a USB 2.0 device, in order to conduct data communications using the USB 3.0 interface it is necessary to redo the logical connection process between the two devices. One method for doing so is to unplug the USB 3.0 cable from, and re-plug it into, the USB 3.0 ports. However, the operation of unplugging and re-plugging in the cable is troublesome for a user, and it is undesirable to leave a user with no other choice but to perform the un-unplugging and re-plugging in operations. This sort of problem is not limited to peripheral devices that can utilize the USB 2.0 interface and the USB 3.0 interface, but is a common problem for peripheral devices having a single connector capable of allowing connections of multiple types of interfaces having different specifications for data communications.

An object of the present invention is to provide technology for reducing the possibility that erroneous logical connections using interfaces will form when a peripheral device is physically connected to a host device through a connector.

### SUMMARY OF THE INVENTION

The present invention is applied to a peripheral device operable to conduct data communications with a host device by selectively using any one of multiple types of interfaces having different specifications with regard to data communication, and the object described above is achieved by having:

a single connection portion configured to selectively connect to multiple types of connectors corresponding to the multiple types of interfaces, the connection portion including a power terminal for receiving a supply of power from the host device via a connector;

a control section for initiating, upon receiving a supply of power, a connection process to form a logical connection with the host device by using any one of the multiple types of interfaces;

a power line connecting the control section and the terminal; and

a delay process section for delaying, despite power having been supplied from the host device to the peripheral device, supply of power to the control section for a predetermined time, the delay process section being disposed along the power line.

Generally, contacts between terminals on a connection portion, and terminals on a connector become stabilized and the possibility of forming a desired interface becomes higher when the connection process for forming a logical connection is conducted after a certain time has elapsed since a physical connection is established. With the peripheral device described above, the start of the connection process can be delayed by having the delay process section delaying supply of power to the control section for a predetermined time. As a result, the possibility of forming a logical connection using an incorrect interface can be reduced.

Here, the delay process section may be a delay circuit including a capacitor.

The possibility of forming a logical connection using an incorrect interface can be reduced, by adopting a simply configuration in which the delay circuit including the capacitor is incorporated along the power line.

Furthermore, the multiple types of interfaces at least includes

a first type of interface conforming to USB 2.0, and

a second type of interface conforming to USB 3.0.

The possibility of the host device mistakenly recognizing the peripheral device as a USB 2.0 device when it should be recognized normally as a USB 3.0 device can be reduced. As a result, there is a reduced possibility of conducting data communication by using the USB 2.0 interface despite having a capability of conducting high speed data communication using the USB 3.0 interface.

Furthermore, other than the above described configuration as a peripheral device, the present invention can also be achieved as an interface connection method for a peripheral device and a host device, a control method for a peripheral device, or a computer program for controlling a peripheral device. The computer program may be stored in a computer readable storage medium. The storage medium that can be used includes, for example, various media such as magnetic disks, optical discs, memory cards, and hard disks.

### BRIEF DESCRIPTION OF THE DRAWINGS

FIG. 1 is a block diagram showing an outlined configuration of a peripheral device which is one embodiment of the present invention;

FIG. 2A shows a terminal arrangement of a port;

FIG. 2B shows a terminal arrangement of a connector; and

FIG. 3 is a flowchart indicating a logical connection process conducted by the host device and the peripheral device which is one embodiment of the present invention.

### DESCRIPTION OF THE PREFERRED EMBODIMENTS

An embodiment of the present invention will be described in the following.

### Embodiment

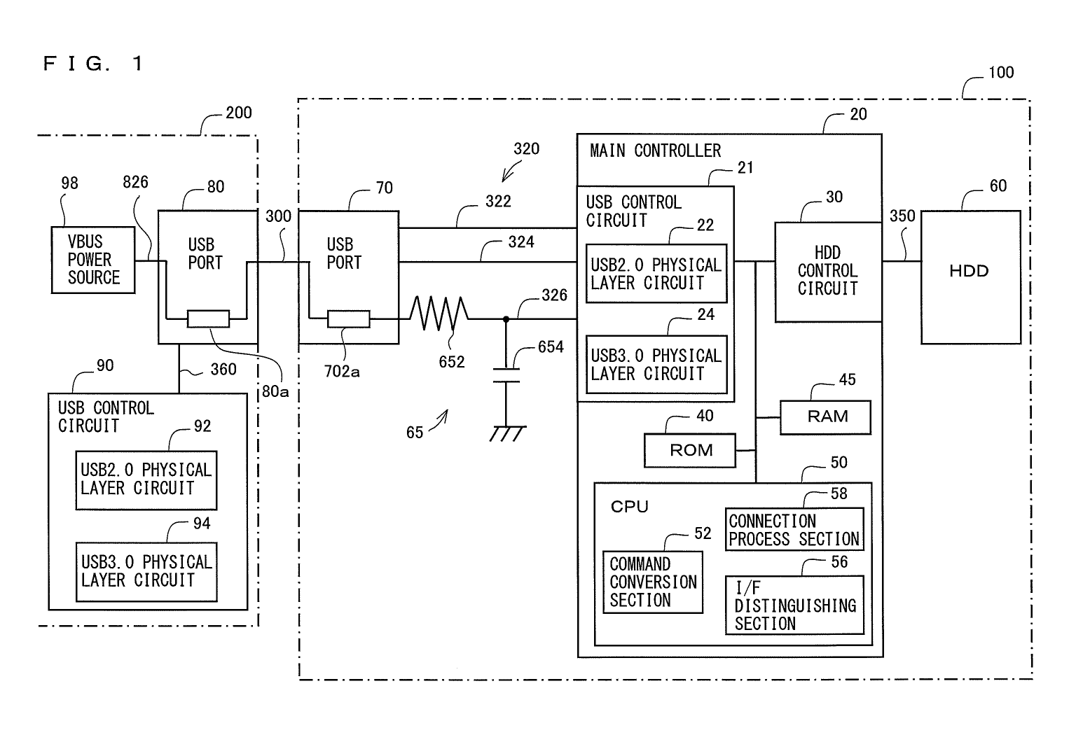

FIG. 1 shows an outlined configuration of a peripheral device according to one embodiment of the present invention. In order to allow an easily understandable description, FIG. 1 shows a mode in which a peripheral device 100 and a host device 200 are physically connected via a cable 300 (also referred to as a USB cable 300). In the present embodiment, the peripheral device 100 is an external storage device 100 which is used as an external device. Furthermore the host device 200 is a personal computer (referred to as a PC hereinafter) 200.

The external storage device 100 includes a main controller 20, a hard disk drive (also referred to as “HDD” hereinafter) 60, a USB port 70, and a delay process section 65.

The USB port 70 has a shape conforming to USB 3.0, and is capable of selectively connecting to a male type connector conforming to USB 2.0 or a male type connector conforming to USB 3.0. Specifically, the USB port 70 is a port capable of selectively connecting to Standard-B conforming to USB 2.0 (referred to as a USB 2.0 B connector hereinafter) or Standard-B conforming to USB 3.0 (referred to as a USB 3.0 B connector hereinafter). Here, to be “capable of selectively connecting” refers to the capability of connecting either to the USB 2.0 B connector or the USB 3.0 B connector but not simultaneously connecting to both.

Included in the inside of the main controller 20 is a USB control circuit 21, an HDD control circuit 30, a ROM (Read Only Memory) 40, a RAM (Random Access Memory) 45, and a CPU (Central Processing Unit) 50. These components are connected to each other via an internal bus.

Data communication conforming to either USB 2.0 or USB 3.0 is conducted between the external storage device 100 and the PC 200 connected thereto via the USB cable 300 and a signal line 320. Furthermore, a bus power method is used for the external storage device 100, where an operation of the external storage device starts when a supply of power from the host device 200 is received via the cable 300. The signal line 320 includes a USB 2.0 signal line 322, a USB 3.0 signal line 324, and a power line 326. The USB 2.0 signal line 322 is used for conducting data communication using USB 2.0 interface. Specifically, the USB 2.0 signal line 322 transmits differential signals via a D+ pin and a D− pin. The USB 3.0 signal line 324 is used for conducting data communication using USB 3.0 interface. Specifically, the USB 3.0 signal line 324 transmits differential signals via terminals for SuperSpeed (simply referred to SS hereinafter). The power line 326 is used for receiving a supply of power from the host device 200 via a power terminal 702a included in the USB port. Thus, the power line 326 connects the power terminal 702a and the main controller 20.

The delay process section 65 is a delay circuit 65 incorporated along the power line 326. The delay circuit 65 of the present embodiment is formed from a so-called primary RC circuit, and includes a resistance 652 that is serially connected to the power line 326, and a capacitor 654 having one end connected to the power line 326 and having the other end grounded. When the external storage device 100 and a VBUS power source 98 of the PC 200 are connected via the cable 300, the delay circuit 65 delays a supply of power from the VBUS power source 98 to the main controller 20 for a predetermined time. The predetermined time can be set by using a time constant determined from the resistance value of the resistance 652 and the capacity of the capacitor 654. The delay circuit 65 includes a circuit for discharging charges accumulated in the capacitor 654. Specifically, in order to discharge the charges, for example, a ground signal line, which is grounded, is provided on the power line 326 positioned between the resistance 652 and the USB port 70. Charges can be discharged by connecting the power line 326 and the ground signal line by using a switch and the like.

The USB control circuit 21 includes a USB 2.0 physical layer circuit 22, and a USB 3.0 physical layer circuit 24. The USB 2.0 physical layer circuit 22 converts, into digital signals, differential signals conforming to USB 2.0 transmitted from the PC 200 via the cable 300. The USB 3.0 physical layer circuit 24 converts, into digital signals, differential signals conforming to USB 3.0 transmitted from the PC 200 via the cable 300.

The HDD 60 is connected to the main controller 20 via a signal line 350. The HDD control circuit 30 controls reading/writing data from/to the HDD 60. The ROM 40 stores therein various programs that are executed by the CPU 50 which is described later. When the external storage device 100 is started up, the various programs are loaded to the RAM 45 from the ROM 40.

In accordance with the various programs which are loaded, the CPU 50 controls conducting data communication with the PC 200 via the USB control circuit 21, and reading/writing data from/to the HDD 60 via the HDD control circuit 30.

As a result of having the above described various programs executed, the CPU 50 functions as a command conversion section 52, an I/F distinguishing section 56, and a connection process section 58. The command conversion section 52 converts a USB interface signal into a SATA (Serial Advanced Technology Attachment) interface signal, and converts a SATA interface signal into a USB interface signal. Thus, the command conversion section 52 has a function of converting signals of multiple different types of interfaces into signals corresponding to each interface.

The I/F distinguishing section 56 distinguishes the type of interface formed between the external storage device 100 and the PC 200. The connection process section 58 conducts a connection process to form a logical connection with the host device 200.

The PC 200 includes a USB port 80 (also referred to as a USB receptacle 80), a USB control circuit 90, and the VBUS power source 98. It should be noted that, although the internal configuration of the PC 200 includes a CPU, a ROM, and the like other than the configuration described above; only the internal configurations necessary for the description are shown here.

The USB port 80 and the USB control circuit 90 are connected to each other through a signal line 360. The USB port 80 has a shape conforming to USB 3.0, and can selectively connect to a male type connector conforming to USB 2.0 and a male type connector conforming to USB 3.0. Specifically, the USB port 80 is a port capable of selectively connecting to Standard-A conforming to USB 2.0 (referred to as a USB 2.0 A connector hereinafter) and Standard-A conforming to USB 3.0 (referred to as a USB 3.0 A connector hereinafter). The USB control circuit 90 and the external storage device 100, which are connected to each other via the USB cable 300 and the signal line 320, conduct data communications conforming to either USB 2.0 or USB 3.0. The USB control circuit 90 includes a USB 2.0 physical layer circuit 92 and a USB 3.0 physical layer circuit 94. Similar to the above described physical layer circuits 22 and 24 of the external storage device 100, the physical layer circuits 92 and 94 convert differential signals conforming to USB 2.0 and USB 3.0 into digital signals, respectively.

The VBUS power source 98 supplies power to the main controller 20 via a power line 826, a power terminal 80a, the USB cable 300, the power terminal 702a, and the power line 326.

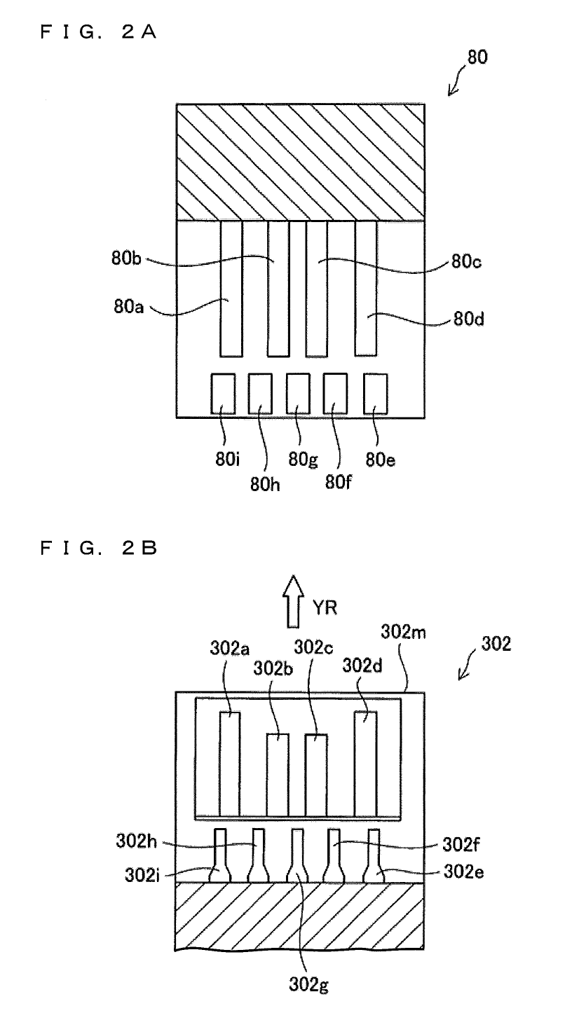

Before describing the logical connection process conducted between the host device 200 and the external storage device 100 of the present embodiment, the arrangement of multiple terminals included in the USB port 80 and a USB 3.0 A connector 302 (USB 3.0 cable plug 302) located at one end of the USB cable 300 will be described by using FIG. 2A and FIG. 2B. FIG. 2A shows the arrangement of multiple terminals of the USB port 80, and FIG. 2B shows the arrangement of multiple terminals of the USB 3.0 A connector 302.

As shown in FIG. 2A, the USB port 80 includes nine terminals 80a, 80b, 80c, 80d, 80e, 80f, 80g, 80h, and 80i. The terminals 80a, 80b, 80c, and 80d are USB 2.0 terminals used in the USB 2.0 interface. The terminals 80e, 80f, 80g, 80h, and 80i are SS terminals used in the USB 3.0 interface. The terminal 80a is a power terminal. The terminal 80b is a D− pin, and the terminal 80c is a D+pin. The terminal 80d is a ground terminal. The terminal 80e is a first terminal for a SS reception circuit, and the terminal 80f is a second terminal for the SS reception circuit. The terminal 80g is a ground terminal for returning signals. The terminal 80h is a first terminal for a SS transmission circuit, and the terminal 80i is a second terminal of the SS transmission circuit. Each of the terminals 80a, 80b, 80c, 80d, 80e, 80f, 80g, 80h, and 80i conforms to USB standard. The USB 2.0 terminals 80a, 80b, 80c, and 80d are arranged at positions different from the SS terminals 80e, 80f, 80g, 80h, and 80i in the height direction (vertical direction with respect to the paper surface). When conducting data communication using the USB 3.0 interface, signals are transmitted by using terminals other than the terminal 80b and the terminal 80c.

As shown in FIG. 2B, the USB 3.0 A connector 302 includes nine terminals 302a, 302b, 302c, 302d, 302e, 302f, 302g, 302h, and 302i which respectively correspond to the terminals 80a, 80b, 80c, 80d, 80e, 80f, 80g, 80h, and 80i of the USB port 80. The terminals 302a, 302b, 302c, and 302d are USB 2.0 terminals, and the terminals 302e, 302f, 302g, 302h, and 302i are SS terminals. The USB 2.0 terminals 302a, 302b, 302c, and 302d are arranged at positions different from the SS terminals 302e, 302f, 302g, 302h, and 302i in the height direction (vertical direction with respect to the paper surface). In addition, the USB 2.0 terminals 302a, 302b, 302c, and 302d are arranged near an opening 302m (near side), and the SS terminals 302e, 302f, 302g, 302h, and 302i are arranged away from the opening 302m (back side). Therefore, when a user moves the USB 3.0 A connector 302 in an arrow YR direction to form contacts between the terminals 302a, 302b, 302c, 302d, 302e, 302f, 302g, 302h, and 302i of the USB 3.0 A connector 302 and the respective terminals 80a, 80b, 80c, 80d, 80e, 80f, 80g, 80h, and 80i of the USB port 80; the SS terminals 80e, 80f, 80g, 80h, and 80i respectively form contacts with the SS terminals 302e, 302f, 302g, 302h, and 302i after the USB 2.0 terminals 80a, 80b, 80c, and 80d respectively form contacts with the USB 2.0 terminals 302a, 302b, 302c, and 302d. Therefore, the SS terminals 80e, 80f, 80g, 80h, and 80i respectively form contacts with the SS terminals 302e, 302f, 302g, 302h when the USB 3.0 A connector 302 is inserted deep in the USB port 80.

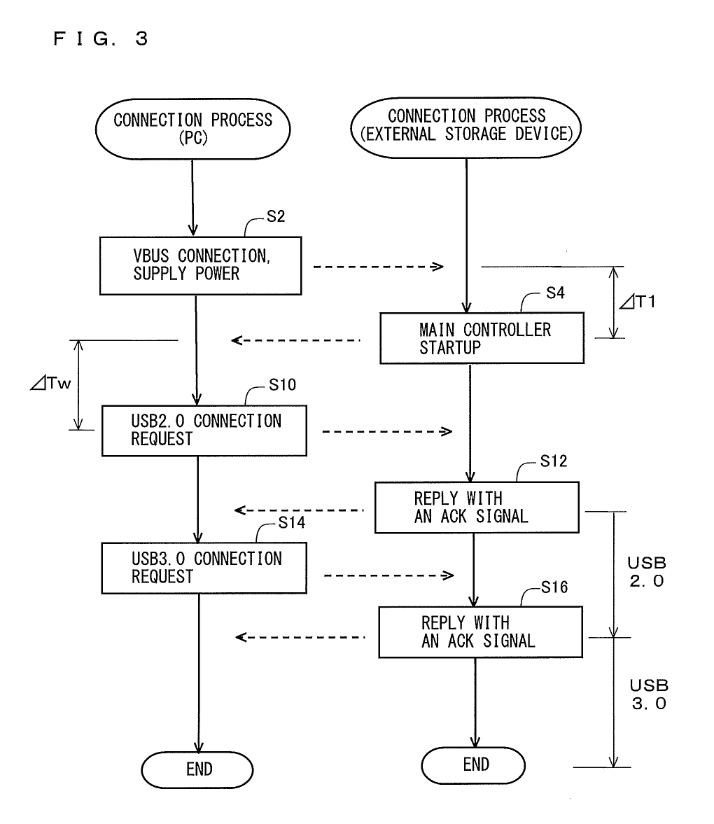

FIG. 3 is a figure for describing the logical connection process conducted between the host device 200 and the external storage device 100 of the present embodiment. The connection process described in the following is a process conducted between the main controller 20 of the external storage device 100 (more specifically the connection process section 58), and a main controller (not shown) of the PC 200. Described here is a logical connection process conducted when the external storage device 100 and the host device 200 are physically connected by using the USB cable 300 that includes a USB 3.0 connector. In addition, described here is a case in which the user inserts the USB 3.0 A connector 302 (FIG. 2B) located at one end of the USB cable 300 into the USB port 80 (FIG. 2A), in a situation where the USB 3.0 B connector located at the other end of the cable 300 is already physically connected to the USB port 70, and where terminals of the USB 3.0 B connector are forming contacts with terminals of the USB port 70 conforming to USB 3.0. Hereinafter, a physical connection is simply referred to as a connection.

When the power terminal 80a and the power terminal 302a form contact with each other, a supply of power to the external storage device 100 from the VBUS power source 98 of the PC 200 is initiated (step S2). When the supply of power is initiated and a predetermined amount of power is supplied to the main controller 20 via the power line 326 (FIG. 1), the main controller 20 starts up (step S4). Here, the power line 326 includes the delay circuit 65 that delays supply of power to the main controller 20 for a predetermined time. Therefore, when compared to a case where the delay circuit 65 is not included, there is a delay for a predetermined time ΔT1 after supplying the predetermined amount of power to the main controller 20 to startup the main controller 20. The predetermined time ΔT1 is set by using a time constant determined from the resistance value of the resistance 652 and the capacity of the capacitor 654 as described above.

A connection process to form a logical connection is initiated after a predetermined time ΔTw has elapsed since the startup of the main controller 20. First, a USB 2.0 connection-request signal is transmitted from the PC 200 to the external storage device 100 in order to form a logical connection using the USB 2.0 interface (step S10). Next, when the external storage device 100 properly receives the USB 2.0 connection-request signal, the external storage device 100 replies to the PC 200 with an ACK signal indicating that the signal has been received properly (step S12). Here, the external storage device 100 replies with the ACK signal when the USB 2.0 terminals 80a, 80b, 80c, and 80d of the USB port 80 form contacts with the corresponding USB 2.0 terminals 302a, 302b, 302c, and 302d of the USB 3.0 A connector 302 (FIG. 2). With this, a logical connection is formed between the external storage device 100 and the PC 200 using the USB 2.0 interface. By having the logical connection using the USB 2.0 interface formed, data communication between the external storage device 100 and the PC 200 using the USB 2.0 interface becomes possible.

The PC 200 that has received the ACK signal in response to the USB 2.0 connection-request signal transmits, to the external storage device 100, a USB 3.0 connection-request signal to form a logical connection using the USB 3.0 interface (step S14). When the external storage device 100 properly receives the USB 3.0 connection-request signal from the PC 200, the external storage device 100 replies to the PC 200 with an ACK signal (step S16). Here, when the SS terminals 80e, 80f, 80g, 80h, and 80i of the USB port 80 are in contact with the corresponding SS terminals 302e, 302f, 302g, 302h, and 302i of the USB 3.0 A connector 302 (FIG. 2), the external storage device 100 replies with the ACK signal. With this, instead the USB 2.0 interface, a logical connection using the USB 3.0 interface is formed and data communication using the USB 3.0 interface becomes possible.

When the external storage device 100 and the PC 200 are physically connected by using a USB 2.0 connector conforming to USB 2.0 standard, the steps described in the following will be taken. Step S2 to step S14 are similar to the steps shown in FIG. 3. However, instead of step S16, the external storage device 100 replies to the PC 200 with a NACK signal indicating that the USB 3.0 connection-request signal has not been properly received. As a result, a logical connection using the USB 3.0 interface is not formed, and the logical connection using the USB 2.0 interface is maintained.

As described above, the external storage device 100 of the present embodiment delays supply of power to the main controller 20 for a predetermined time by using the delay circuit 65, despite power having been supplied from the PC 200 to the external storage device 100 via the power line 326. As a result, the startup of the main controller 20 is delayed for the predetermined time ΔT1 when compared to not having the delay circuit 65 (FIG. 3). This delay of the predetermined time ΔT1 leads to a delay of the start of the logical connection process by the predetermined time ΔT1. Therefore, there is a higher possibility of having the logical connection process initiated after the SS terminals 80e, 80f, 80g, 80h, and 80i of the USB port 80 forming contacts with the SS terminals 302e, 302f, 302g, 302h, and 302i of the USB 3.0 A connector 302. Thus, the possibility can be reduced for mistakenly initiating data communication using the USB 2.0 interface as a result of the logical connection process despite having a capability of conducting data communication using the USB 3.0 interface. As a result, data communication between the external storage device 100 and the PC 200 can be conducted using a desired interface with a high data transmission rate (in the present embodiment, the USB 3.0 interface).

Preferably, the positions of the terminals in a connector and a port, and an average speed of the user inserting a connector into a port are taken into consideration, and the predetermined time ΔT1 is set as a period of time equal to or longer than the time required from when the power terminal 80a forms a contact with the power terminal 302a to when the SS terminals 80e, 80f, 80g, 80h, and 80i to form contacts with the SS terminals 302e, 302f, 302g, 302h, and 302i. With this, the possibility of establishing a logical connection using an incorrect interface as a result of the logical connection process can be reduced. Furthermore the predetermined time ΔT1 is preferably two seconds or shorter. This is because when the predetermined time ΔT1 is longer than two seconds, there is a possibility of the user feeling that the whole operation is troublesome due to the delay when starting the logical connection process.

Here, the USB port 70 corresponds to “a connection portion” described in the claims, and the main controller 20 corresponds to “a control section” described in the claims.

(Modifications)

In the following, modifications of the present embodiment will be described in detail. Among the constituent elements in the above described embodiment, elements other than the elements described in the independent claim of the claims are additive elements, and can be omitted as appropriate. Furthermore, the present invention is not limited to the above described embodiment, and the present invention can be embodied in various mode without departing from the spirit and scope thereof; and, for example, the following modifications are also possible.

(First Modification)

Although the delay process section 65 is used as a delay circuit in the above described embodiment, a reset IC may be used instead. The reset IC is incorporated along the power line 326 to monitor the voltage of the power line 326; and when the voltage rises to or beyond a predetermined value, the reset IC delays an output of a power signal (power) inputted thereto for a predetermined time. Alternatively, the reset IC delays a rise in the voltage of the power line 326 on the downstream of the reset IC for a predetermined time. Similar to the embodiment described above, this modification also allows reducing the possibility of forming a logical connection using an incorrect interface.

(Second Modification)

Although descriptions have been provided for the above described embodiment by using the USB 2.0 interface and the USB 3.0 interface as the two types of interfaces having different specifications for data communications, the present invention is not limited thereto. The present invention can be applied to two or more types of interfaces whose connections are formed selectively by a single connection portion (port) to conduct data communications.

For example, instead of the USB port 70 conforming to USB 3.0 described in the above described embodiment, a USB port conforming to USB 2.0 may be used. This USB port can selectively connect to a male type connector compliant with the USB 2.0 interface and an interface conforming to USB 1.1 (also referred to as USB 1.1 interface). Similar to the embodiment described above, the logical connection process for the USB 1.1 interface and the USB 2.0 interface is initiated when power is supplied from the PC 200 to the main controller 20 of the external storage device 100 and when the main controller 20 starts up (step S4 in FIG. 3). Furthermore, in the logical connection process, when the external storage device 100 did not properly receive a USB 2.0 connection-request signal as a response to the USB 2.0 connection request (step S10 in FIG. 3), the external storage device 100 replies to the PC 200 with a NACK signal. With this, a logical connection using the USB 1.1 interface is formed. On the other hand, when the external storage device 100 properly receives the USB 2.0 connection-request signal, the external storage device 100 replies to the PC 200 with an ACK signal. With this, a logical connection using the USB 2.0 interface is formed. In order to properly receive the USB 2.0 connection-request signal, it is necessary for all the various terminals used for the USB 2.0 interface in the port and the connector to be connected. Therefore, contacts between various terminals can be stabilized and the possibility of forming a logical connection using an incorrect interface (in this case, the USB 1.1 interface) can be reduced, by having the delay process section 65 delaying supply of power from the PC 200 to the main controller 20 of the external storage device 100 for a predetermined time.

Furthermore, the present invention is also applicable to, for example, a peripheral device capable of conducting data communication with a host device by selectively using any one of three types of interfaces, which are USB interfaces of the USB 1.1 interface, the USB 2.0 interface, and the USB 3.0 interface.

(Third Modification)

Although, in the above described embodiment, the supply of power from the PC 200 is always conducted through the delay circuit 65 that functions as a delay process section, a bypass line that bypasses the delay circuit 65 may be provided. In this case, a switch that is capable of switching between a circuit that passes through the delay circuit 65 and a circuit that passes through the bypass line is provided. The switch preferable has a configuration that allows the user to switch between circuits from outside the external storage device 100. As a result, it can be determined in accordance with a request by the user, whether to prioritize to apply a usual time period for the time required for the completion (also referred to as “completion time”) of the logical connection process that has started when a power terminal is connected, or to delay the completion time by the predetermined time ΔT1 and to reduce the possibility of forming a logical connection using an incorrect interface. In other words, the peripheral device preferably has a first mode of conducting supply of power from the host device to the control section as usual, and a second mode of delaying, for a predetermined time, supply of power to the control section despite power having been supplied from the host device to the peripheral device for a predetermined time; and the peripheral device also includes a switch section allowing the user to switch between the first mode and the second mode.

Furthermore, the external storage device 100 may have a configuration that allows using other power sources such as a commercial power source and an internal power source (battery). As a result, if there is a shortage in the supply of power through the bus power method and when the main controller does not start up, the main controller 20 can be started up by receiving a supply of power from another power source. Thus, if there is a shortage of power in the main controller 20 after the main controller receives a supply of power from the PC 200 via the power line 326, power can be compensated from another power source. Furthermore, the main controller 20 may be started up by switching to another power source after the main controller 20 has received the supply of power from the PC 200 via the power line 326.

(Fourth Modification)

Although, in the above described embodiment, descriptions have been provided by using, as an example of the peripheral device of the present invention, the external storage device 100 which is used as an external device and in which the HDD 60 is built-in, the peripheral device of the present invention is not limited thereto. For example, the present invention can be applied to external storage devices in which various storage media such as a flash memory, an optical disc, and the like are built-in. Furthermore, the present invention can be applied to electronic devices such as external storage devices, printers, cameras, tuners for digital televisions, and the like. In addition, the host device is not limited to the personal computer, and various computer apparatuses functioning as computing machines may be used as the host device.

(Fifth Modification)

In the above described embodiment, one part of the configuration attained by software may be substituted with hardware, or instead, one part of configuration attained by hardware may be substituted with software.

What is claimed is:

1. A peripheral device selectively using multiple types of interfaces having different specifications for data communications to conduct data communications with host devices, the peripheral device comprising:
a connection portion configured to selectively connect to multiple types of connectors corresponding to the multiple types of interfaces, the connection portion including a power terminal for receiving a supply of power from the host device via a connector;
a control section for initiating, upon receiving a supply of power, a connection process to form a logical connection with the host device by using any one of the multiple types of interfaces;
a power line connecting the control section and the terminal; and
a delay process section for delaying supply of power to the control section having started by the connector being connected to the connection portion, for a predetermined time from supply start, the delay process section being disposed along the power line.

2. The peripheral device according to claim 1, wherein the delay process section is a delay circuit including a capacitor.

3. The peripheral device according to claim 1, wherein the multiple types interfaces at least include
a first type of interface conforming to USB 2.0, and
a second type of interface conforming to USB 3.0.

4. The peripheral device according to claim 2, wherein the multiple types interface at least include
a first type of interface conforming to USB 2.0, and
a second type of interface conforming to USB 3.0.
